(19) United States
(12) Patent Application Publication
(10) Pub. No.: US 2011/0316448 A1
(43) Pub. Date: Dec. 29, 2011

(54) SYSTEM AND APPARATUS FOR CONTROLLING LIGHT INTENSITY OUTPUT OF LIGHT EMITTING DIODE ARRAYS

(75) Inventor: Ian Edward Ashdown, West Vancouver (CA)

(73) Assignee: KONINKLIJKE PHILIPS ELECTRONICS N.V., EINDHOVEN (NL)

(21) Appl. No.: 13/255,118

(22) PCT Filed: Feb. 23, 2010
(86) PCT No.: PCT/IB2010/050794

§ 371 Date: Sep. 7, 2011

Related U.S. Application Data
(60) Provisional application No. 61/158,648, filed on Mar. 9, 2009.

(51) Int. Cl. H05B 37/02; G06G 7/62; G06F 17/11

(52) U.S. Cl. 315/297; 703/2

(57) ABSTRACT

Disclosed herein is a system for controlling a drive current of an LED that includes a controller configured to estimate a junction temperature of the LED at a location of a heat sink. The system also includes a driver configured to change a drive current to the LED in response to a command from the controller. Also disclosed is a method of determining drive currents for LEDs in an array that includes determining a required light output intensity at a first time for each LED; estimating heat generated by each LED at the first time; solving heat flow equations for the array at the first time; estimating a junction temperature for each of the LEDs at the first time; and determining a drive current for the required light intensity at the first time for each of the LEDs based on the junction temperature.

### TECHNICAL FIELD

The present invention is directed generally to light emitting diode (LED) arrays. More particularly, various inventive methods and apparatus disclosed herein relate to a method and system to control light intensity output of LED arrays.

### BACKGROUND

Digital lighting technologies, i.e. illumination based on semiconductor light sources, such LEDs, offer a viable alternative to traditional fluorescent, HID, and incandescent lamps. Functional advantages and benefits of LEDs include high energy conversion and optical efficiency, durability, lower operating costs, and many others. Recent advances in LED technology have provided efficient and robust full-spectrum lighting sources that enable a variety of lighting effects in many applications. Some of the fixtures embodying these sources feature a lighting module, including one or more LEDs capable of producing different colors, e.g. red, green, and blue, as well as a processor for independently controlling the output of the LEDs in order to generate a variety of colors and color-changing lighting effects, for example, as discussed in detail in U.S. Pat. Nos. 6,016,038 and 6,211,626, incorporated herein by reference.

High flux LEDs are often used in arrays for display devices. One type of display is known as a high dynamic range (HDR) display, in which an LED array is mounted behind a diffuser to provide backlighting for the LCD panel. However, whereas the LEDs of many known LCD monitors are designed to provide backlighting with spatially uniform luminance, the intensity of each LED in an HDR display is individually modulated. In operation, each frame of a video stream is down-sampled to generate an image having a resolution equal to the number of rows and columns of the LED array. This low-resolution image then illuminates the high-resolution image displayed on the LCD panel. The viewer then perceives the original high-resolution video image with dynamic ranges as high as 200,000:1, compared to the typical dynamic range of 500:1 for many known LCD monitors.

While heat-sinks have been used to realize thermal equilibrium in known (not HDR) displays, achieving thermal equilibrium in HDR displays is not practical. Notably, the LEDs are either phosphor-coated InGaN LEDs or red-green-blue LED clusters with both InGaN and AIInGaP LEDs. As should be appreciated by one of ordinary skill in the art, the intensity of both InGaN and AIInGaP LEDs is dependent on the LED junction temperature. The junction temperature is further dependent on the drive current and the temperature of the heat sink at the point of contact with the LED package. While the drive current is known, the temperature distribution of the heat sink is unknown, and so the LED intensities cannot be predicted.

Unfortunately, high flux LEDs convert only approximately 15% to approximately 25% of drive energy into light, with the rest of the drive energy dissipated as heat. LEDs that emit light in the red-wavelengths can experience a drop in output intensity of as much as 50%, whereas LEDs that emit light of green and blue wavelengths experience light intensity decreases on the order of approximately 5% to approximately 20%. Thus, reductions in light intensity due to increased operating temperatures can not only reduce the overall light intensity provided by the high flux LEDs (e.g., brightness of a display incorporating the LEDs), but also can distort images based on a certain portion of red light, blue light and green light due to the non-uniform changes in the output of differing LEDs.

Many commonly used LEDs are either phosphor-coated InGaN LEDs or red-green-blue LED clusters with both InGaN and AIInGaP LEDs. The intensity of both InGaN and AIInGaP LEDs is dependent on the LED junction temperature. The junction temperature is further dependent on the drive current and the temperature of the heat sink at the point of contact with the LED package. While the drive current is known, the temperature distribution of the heatsink is unknown, and so the LED intensities cannot be predicted.

A consequence of this difficulty in predicting the LED intensity levels may be understood by considering an HDR display that displays a constant image of a white square on a black background for an hour or so. In this situation, the heatsink will reach thermal equilibrium. Depending on the thermal resistances between LED packages, the temperature differences between illuminated and non-illuminated LEDs may be tens of degrees Celsius. If the video image is suddenly changed to be completely white, the previously non-illuminated LEDs will initially have lower junction temperatures and thus high intensities. The viewer will perceive a low resolution negative image of the square that slowly fades as the heatsink approaches its new thermal equilibrium.

There is therefore a need for a method and apparatus to predict the temperature distribution of the heatsink of an LED array such that the intensity of each LED can be predicted at video rates of 30 to 120 frames per second. One possible solution is to measure the forward voltage of each LED at the beginning of each video frame. As will be known to those skilled in the art, the forward voltage of an LED is dependent on the junction temperature, and so may be used as a proxy measurement for the junction temperature. In combination with the drive current, this measurement allows the LED intensity to be determined.

The disadvantage of this solution is that it requires a high-speed, high-resolution analog-to-digital converter to measure the forward voltage of up to one thousand or more LEDs. This solution is expensive and therefore impractical.

Thus, there is a need in the art for a method and system to control light intensity output of LED arrays that overcomes at least the shortcomings described above.

### SUMMARY

In a representative embodiment, the invention focuses on a system for controlling a drive current of an LED that includes a controller configured to estimate a junction temperature of the LED at a location of a heat sink. The system also includes a driver configured to change a drive current to the LED in response to a command from the controller.

In another representative embodiment, a method of determining drive currents for LEDs in an array includes determining a required light output intensity at a first time for each LED; estimating heat generated by each LED at the first time; solving heat flow equations for the array at the first time; estimating a junction temperature for each of the LEDs at the first time; and determining a drive current for the required light intensity at the first time for each of the LEDs based on the junction temperature.

In yet another representative embodiment, a computer readable medium encoded with a computer readable program code for predicting drive currents of LEDs of an array includes instructions operative to: determining a required light output intensity at a first time for each LED of the array; estimate heat generated by each LED at the first time; solve heat flow equations for the array at the first time; estimate a junction temperature for each of the LEDs at the first time; and determine the drive current for the required light intensity at the first time for each of the LEDs based on the junction temperature.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates a light source comprising an LED array and heat sink in accordance with a representative embodiment.

FIG. 2 is a simplified schematic block diagram of a display, a heat sink and electronic components to model drive currents in accordance with a representative embodiment.

FIG. 3 is a flow chart of a method of controlling drive current in LEDs in accordance with a representative embodiment.

### DETAILED DESCRIPTION

In view of the shortcomings associated with variation in light intensity of LEDs in certain applications, a method and system are described to control the drive currently. More generally, Applicants have recognized and appreciated that it would be beneficial to predict the junction temperature of LEDs and adjust the drive current required to meet an intensity requirement in a future frame. In the following detailed description, for purposes of explanation and not limitation, representative embodiments disclosing specific details are set forth in order to provide a thorough understanding of the present teachings. Descriptions of known devices, materials and manufacturing methods may be omitted so as to avoid obscuring the description of the representative embodiments. Nonetheless, such devices, materials and methods that are within the purview of one of ordinary skill in the art may be used in accordance with the representative embodiments.

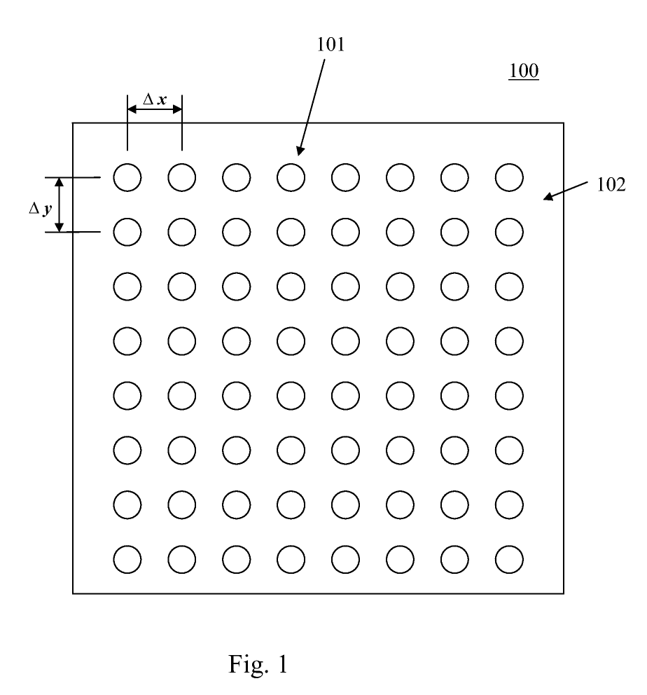

Referring to FIG. 1, in a representative embodiment, a light source 100 comprises an array of LEDs 101 disposed over and in thermal contact with a heat sink 102. As should be appreciated, the LEDs 101 of the light source are provided in packaged form, and may be referred to herein as LED packages accordingly.

The light source 100 may be provided in a display device, such as an HDR display; and the LEDs may be high-flux LEDs. These applications are merely illustrative, and other applications are contemplated. These applications include other display and lighting applications, especially where control over the output intensity of the LEDs 101 is useful. Such applications will be within the purview of one of ordinary skill in the art having had the benefit of the present disclosure.

The heat sink 102 may be a metal/metal alloy and be configured to dissipate passively heat generated by the LEDs 101 to the ambient. Alternative materials and configurations are contemplated; and will be within the scope of knowledge of the ordinarily skilled artisan having had the benefit of the present disclosure. As described more fully herein, the heat sink 102 generally will not reach a state of thermal equilibrium with the array of LEDs 101 due to time-varying changes in the heat output of the LEDs; and because the heat sink is not maintained at a constant temperature by other than the ambient in the interest of practicality and cost. As such, and as will become clearer as the present description continues, representative embodiments comprise a system and method to predict or estimate the temperature of each LED 101 at a future point in time; determine the drive current required for a desired output intensity given this predicted junction temperature; and drive the LED at the calculated drive current at the point in time. The predicting or estimating is effected via modeling methods described below.

One of ordinary skill in the art should appreciate the lattice of LEDs and thermal impedance elements as a lumped impedance representation of a plate with multiple heat sources. Its transient two-dimensional heat distribution can be represented by the two-dimensional heat diffusion equation:

$$\frac{\partial T}{\partial t} = \frac{K}{c ρ} ( \frac{{\partial }^{2} T}{\partial {x}^{2}} + \frac{{\partial }^{2} T}{\partial {y}^{2}} ) \qquad ( 1 )$$

where T is the temperature, t is time, K is the thermal conductivity, c is the specific heat capacity and p is the material density. In a representative embodiment, the heatsink is aluminum, and the values for the noted parameters for the heat diffusion equation are: K=250 watts/meter-Kelvin; c=0.902 Joules/gram-Kelvin; and ρ=2.70 grams/cm³.

In a representative embodiment, the matrix of LED packages 101 is includes equally spaced LED packages 101, where the spacing in x is equal to the spacing in y, and as shown in FIG. 1, the spacing is given by: Δx=Δy=h on the heatsink 102. Given this matrix arrangement, the heat diffusion equation can be solved at time intervals Δt using the finite difference equation:

T_{i,j}(t+1)=r(T_{i-1,j}(t)+T_{i+1,j}(t)+T_{i,j-1}(t)+T_{i,j+1}(t)−4T_{i,j}(t))+T_{i,j}(t) (2)

where (i, j) represents the i^{th} row and j^{th} column of the LED array, and where:

$$r = \frac{K Δ t}{{cph}^{2}} \qquad ( 3 )$$

Illustratively, the time interval Δt is chosen such that r≦0.25 to provide numerical stability when solving the finite difference equation (Eqn. (2)). Iteratively solving this equation for each LED package yields the transient temperature distribution across the heat sink.

Notably, the special case where Δx=Δy=h is provided as an illustration of a representative embodiment, and is not intended to limit the scope of the embodiments or the appended claims. Rather, matrices of LED packages 101 may be spaced so that Δx≠Δy, but the spacing of LED packages 101 in each direction is substantially uniform (i.e., Δx is substantially uniform across the heat sink 102 and Δy is substantially uniform across the heat sink 102). Still alternatively, the spacing of the LED packages 101 may be non-uniform or piece-wise uniform. As to the former, and as will be appreciated by one of ordinary skill in the art, approximations of the spacing may be made for ease of calculations. As to the latter, the spacing may be substantially uniform in either x, or y, or both, in certain portions of the array, and not uniform in certain regions. Again, mathematical modeling of the spacing may be effected to realize the heat diffusion of the light source 100.

In accordance with representative embodiments, more sophisticated solution techniques such as the Crank-Nicholson and alternating direction implicit (ADI) methods may be used to decrease the computational load for real-time applications. Additional details of such methods may be found for example in “Numerical Recipes in C” by Press, W. H., B. P. Flannery, S. A. Teukolsky, and W. T. Vetterling. Cambridge University Press, Chapter 19 (1992). The disclosure of this chapter is specifically incorporated herein by reference.

In representative embodiments, the heat sink 102 may comprise mounting pads for the LEDs, cooling fins, mechanical supports, forced air or water flow and similar structures useful for heat dissipation. As should be appreciated by one of ordinary skill in the art, each structure of the heat sink 102 impacts the boundary conditions for the partial differential equation (s) (the heat diffusion equation) used to model the heat dissipation. Such boundary conditions are usefully taken into consideration. The more complex the boundary conditions, the greater the requirements of the mathematical tools required to effect the modeling of the heat generation, heat dissipation, junction temperatures and drive currents. In order to effect these calculations, the present teachings contemplate thermal analysis techniques, including finite element methods, Monte Carlo simulations, spectral methods and variational methods. The choice of technique will depend on the complexity of the heat sink model and the available processing power needed to solve the equations in real time.

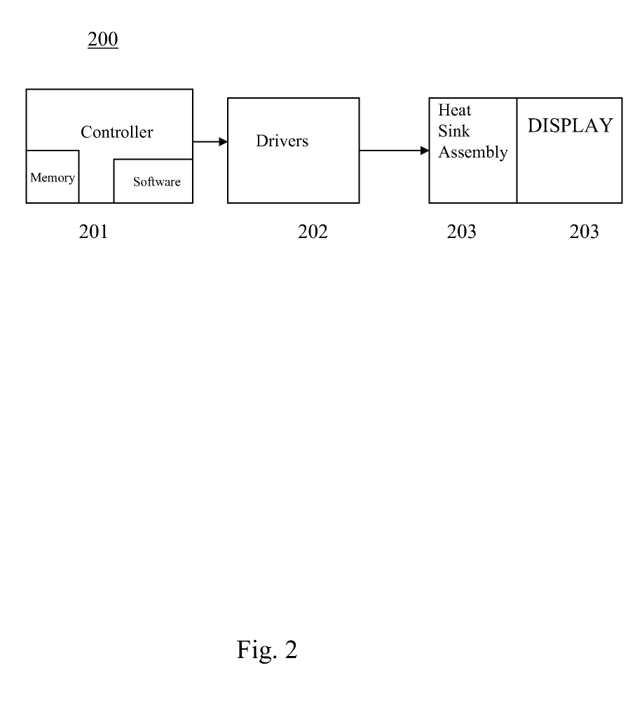

FIG. 2 is a simplified schematic block diagram of a system 200 in accordance with a representative embodiment. The system 200 comprises a controller 201 in electrical connection with a driver 202. The driver 202 is in electrical connection with a heat sink assembly 203. The heat sink assembly 203 comprises a heat sink and a matrix of LEDs, and is used in connection with or is a part of a display 204. The heat sink assembly 203 may be as described in connection with the embodiment of FIG. 1, for example.

In a representative embodiment, the controller 201 comprises a microprocessor with a memory (e.g., a Harvard architecture microprocessor) and software cores (cores) instantiated therein. Alternatively, other types of programmable logic may be used for the controller. Illustratively, programmable logic devices (PLDs) such as field programmable gate arrays (FPGAs) may be used as the controller 201. Still alternatively, the controller 201 may comprise an application specific integrated circuit (ASIC). In representative embodiments the controller 201 can be implemented in programmable graphics hardware, such as the nVidia GeForce Graphics Processor Unit (GPU) from nVidia Corporation, Santa Clara, Calif. The representative GPU, which contains on the order of 128 processor units, is commonly used to process synthetic and live-action video streams for computer games.

Beneficially, GPUs are designed expressly for parallel processing of video streams. In a representative embodiment, the GPU would perform the operations described in connection with methods of representative embodiments below and using multiple processor units. By using computer graphics techniques such as described in: “Generic Data Structures for Graphics Hardware,” PhD thesis, University of California at Davis, January 2006-Chapter 12, “A Heat Diffusion Model for Interactive Depth of Field Simulation” by A. E. Lefohn, et al., the two-dimensional heat diffusion equation can be solved in real time using a small fraction of the GPU computing resources. The disclosure of this publication is specifically incorporated herein by reference.

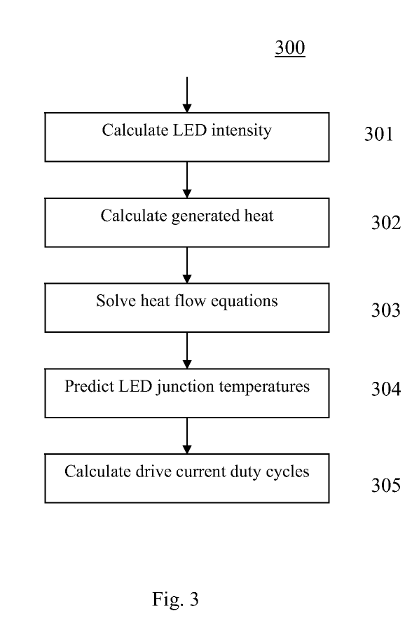

Consequently, the modeling of junction temperatures and the calculation of drive currents for each LED can be performed substantially simultaneously by the system 200. Beneficially, the graphics calculations' may be performed on the original video stream for high dynamic range display. One benefit of the use of GPUs in accordance with the present teachings is their performance in parallel processing of video streams. In an illustrative embodiment, the GPU of the controller 201 perform the operations described above and in connection with the embodiments of FIG. 3 using multiple processor units. For instance, currently available GPUs feature up to 128 processor units.

In accordance with representative embodiments, the two-dimensional heat diffusion equation (Eqn. 1) can be solved in real time using a small fraction of the GPU computing resources. Consequently, the operations required for modeling the junction temperature and setting drive currents for the LEDs of the array can be performed simultaneously with graphics calculations being performed on the original video stream for high dynamic range display. GPUs are part of the ongoing development of general-purpose microprocessors with multiple cores. It is expected that the parallel processing functionality currently available in GPUs will become available in general-purpose microprocessors, and that they will also be able to execute the calculations needed to solve for the transient temperature distribution of the LED heatsink in real time.

After modeling the junction temperature for each LED of the array using modeling methods described above, the controller 201 determines for a particular frame of video or other time the required light intensity for each LED. As should be appreciated by one of ordinary skill in the art, the required drive current for a desired light intensity is dependent upon the junction temperature. As such, the controller 201 calculates the drive current needed for the required intensity of each LED of the array based on its modeled junction temperature. The controller 201 may calculate the drive current algorithmically or may include a look-up table in memory. In the case of the former, the algorithm may calculate the required drive current for the intensity level using modeling methods and LED output characteristics. In the case of the latter, a simple correlating look-up table that includes a drive current value for a desired intensity level. Regardless of the method of determining the drive current, once determined, the controller sends commands to the driver 202, which in turn supplies the requisite drive current for each LED of the array. This process repeats for each LED at time intervals (e.g., frame frequency).

FIG. 3 is a flow-chart of a method 300 of controlling drive current in LEDs in accordance with a representative embodiment. The method may be incorporated into system 200 described previously and instantiated in software, firmware or hardware, or a combination thereof in controller 201 such as previously described. The method of the present embodiment illustrates application to a display such as an HDR display that requires the determination in real time (e.g., 30 times per second to 120 times per second) of the temperature distribution of the junction temperature of the array of LEDs 101 (e.g., 700 LEDs). As briefly described above, this requires solving a matrix of equations with thousands of elements to represent the heat flow between the LEDs 101 on heat sink 102.

In operation, the controller 201 receives a low-resolution video frame. At 301, the method comprises calculating the instantaneous intensity required for each LED 101 at a future time. These calculations are based on video feed information and the methods of calculating the required intensity are known.

At 302, the method comprises calculating the heat generated by each LED 101 at that future time. The calculated heat generated by each LED 101 on the heat sink 102 is based on the required intensity levels from the calculations of 301. As noted previously, the more complex the boundary conditions, the greater the requirements of the mathematical tools required to effect the modeling of the heat generation, heat dissipation, junction temperatures and drive currents. In order to effect these calculations, the present teachings contemplate thermal analysis techniques, including finite element methods, Monte Carlo simulations, spectral methods and variational methods. The choice of technique will depend on the complexity of the heat sink model and the available processing power needed to solve the equations in real time.

Once the modeling of the heat diffusion is completed at 302, a topography of the heat distribution is provided. From these computations, the temperature of the junction of each LED is modeled or predicted. Again, this prediction is for the required intensity for the LEDs from 301. As such, at 304, the LED junction temperatures for the LEDs 101 are predicted.

Based on the junction temperatures predicted at 304, at 305 the method comprises calculating the drive current duty cycle needed for each LED to generate the required LED intensity at the future time. The method 300 then begins again at 301 for the next set of requirements of the video output. A particular advantage of the method 300 is that the LED array and heat sink thermal properties need to be determined only during product design and development. Once the physical design has been finalized, the same thermal model can be applied to any manufactured device.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A system for controlling a drive current of an LED, comprising:
a controller configured to estimate a junction temperature of the LED at a location of a heat sink; and
a driver configured to change a drive current to the LED in response to a command from the controller.

2. A system as claimed in claim 1, wherein the estimated junction temperature is based on a future output intensity of the LED.

3. A system as claimed in claim 1, wherein the controller is configured to calculate heat generated by the LED at a future output intensity of the LED.

4. A system as claimed in claim 3, wherein the controller is configured to solve a heat flow equation based on the calculated heat generated and to estimate the junction temperature.

5. A system as claimed in claim 4, wherein the controller is configured to calculate a drive current required to drive the LED to provide a required output intensity at a future time.

6. A system as claimed in claim 1, wherein the LED is one of an array of LEDs disposed over a heat sink.

7. A system as claimed in claim 1, wherein the controller comprises a microprocessor and a memory comprising a look-up table.

8. A system as claimed in claim 6, wherein the look-up table comprises drive current and output intensity data for the LED.

9. A system as claimed in claim 1, wherein the controller further comprises a computer-readable medium operative to estimate the junction temperature.

10. A system as claimed in claim 1, wherein the controller further comprises a graphic programming unit configured to calculate a drive current and substantially simultaneously process a video stream.

11. A method of determining drive currents for LEDs in an array, the method comprising:
determining a required light output intensity at a first time for each LED;
estimating heat generated by each LED at the first time;
solving heat flow equations for the array at the first time;
estimating a junction temperature for each of the LEDs at the first time; and
determining a drive current for the required light intensity at the first time for each of the LEDs based on the junction temperature.

12. A method as claimed in claim 9, comprising, repeating the steps for a second time that is after the first time.

13. A method as claimed in claim 9, wherein the estimating the junction temperature further comprises modeling the junction temperature based on a heat distribution across the array.

14. A method as claimed in claim 9, wherein the LEDs of an array are provided over a heat sink.

15. A method as claimed in claim 9, wherein the solving the heat flow equations for the array further comprises determining boundary conditions based on one or more structures of the heat sink.

16. A computer readable medium encoded with a computer readable program code for predicting drive currents of LEDs of an array, the computer readable program code comprising instructions operative to:
determining a required light output intensity at a first time for each LED of the array;
estimate heat generated by each LED at the first time;
solve heat flow equations for the array at the first time;
estimate a junction temperature for each of the LEDs at the first time; and
determine the drive current for the required light intensity at the first time for each of the LEDs based on the junction temperature.
